(19) United States
(12) Patent Application Publication
(10) Pub. No.: US 2006/0042607 A1
(43) Pub. Date: Mar. 2, 2006

(54) Intercooler

(75) Inventors: Haruhiko Watanabe, Chiryu-city (JP); Yasutoshi Yamanaka, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/211,031

(22) Filed: Aug. 24, 2005

(30) Foreign Application Priority Data
Aug. 26, 2004 (JP) 2004-246827
Jul. 28, 2005 (JP) 2005-219021

(51) Int. Cl. F02B 29/04; F02B 33/00

(52) U.S. Cl. 123/563; 60/599

(57) ABSTRACT

An intercooler comprises: tubes 10 in which the suction air of an internal combustion engine flows; and inner fins 11 for dividing passages in the tubes into a plurality of minute passages 100, wherein the intercooler is characterized in that when a cross sectional area in one tube 10 is S, a total passage area of the minute passages 100 in one tube 10 is Swa and an equivalent circle diameter of one minute passage 100 is de (unit: mm), the most appropriate specification of the core of the intercooler is found when de/(S/Swa) is used as a parameter. For example, in the case of an intercooler in which the inner fins 11 are straight fins and the supercharging air pressure is not less than 200 kPa, when de/(S/Swa) is made to be 0.2 to 7.5, it is possible to provide an intercooler with high performance.

### BACKGROUND OF THE INVENTION

1. Field of the Invention

The present invention relates to an intercooler for cooling combustion air (suction air) sucked into an internal combustion engine.

2. Description of the Related Art

In an internal combustion engine having a supercharger and used for a heavy-duty truck, the supercharging pressure is set at about 180 kPa at the present time in many cases. In this connection, the pressure described in this specification is gauge pressure. The intercooler used at the present time is usually made of aluminum. For example, refer to the official gazette of JP-A-10-292996.

In this connection, in order to correspond to the regulation of exhaust gas discharged from a heavy-duty truck, which will be strengthened in the future, investigations are made into internal combustion engines used for heavy-duty trucks, the supercharging pressure of which will be higher. According to the increase in the supercharging pressure, it is required that the pressure resistance and the heat resistance of the intercooler are greatly enhanced.

However, in the case of an intercooler made of aluminum, as the mechanical strength of the intercooler is remarkably deteriorated at high temperatures, it is necessary to greatly increase the wall thickness of the intercooler. Therefore, it becomes necessary to change the material.

### SUMMARY OF THE INVENTION

It is an object of the present invention to enhance the performance of an intercooler by finding conditions in which the high performance of the intercooler is obtained in the case where the supercharging pressure is made higher than the commonly used supercharging pressure or in the case where the material of the intercooler is changed.

In order accomplish the above object, the present invention provides an intercooler, which is arranged on the downstream side of a supercharger for pressurizing suction air of an internal combustion engine, for cooling the suction air by exchanging heat between the suction air and a cooling fluid, the intercooler comprising: tubes (10) composing passages in which the suction air flows; and inner fins (11), which are arranged in the tubes (10) so that the passages in the tubes (10) can be divided into a plurality of minute passages (100), for facilitating the heat exchange conducted between the suction air and the cooling fluid, wherein the inner fins (11) are straight fins, the wall faces (110) dividing the minute passages (100) are linearly extended in the flowing direction of the suction air, and the supercharging pressure is not less than 200 kPa, and the intercooler is characterized in that: when a cross sectional area in one tube (10) is S, a total passage area of the minute passages (100) in one tube (10) is Swa and an equivalent circle diameter of one minute passage (100) is de (unit: mm), de/(S/Swa) is 0.2 to 7.5.

In this connection, the equivalent circle diameter de described in this specification is defined as de=4×(Th−2×tt−ti)×(d/2−ti)/[2×((Th−2×tt−ti)+(d/2−ti))], wherein Th is the height of the tube (10) in the laminating direction, tt is the wall thickness of the tube (10), and ti is the wall thickness of the inner fin (11).

In this connection, according to the investigations made by the present inventors, the following was made clear. The engine output Ps of an actual vehicle is proportional to the density of the supercharging air at the outlet of the intercooler. Therefore, the present inventors made investigations to find the most appropriate specification of the core of the intercooler from the relation between the density of the supercharging air and the equivalent circle diameter de of the minute passage. However, the following problems were found. The value of the equivalent circle diameter de, at which the supercharging air density is maximized, changes according to the wall thickness of the inner fin. Therefore, it was found that finding the most appropriate specification of the core of the intercooler, using as a parameter the equivalent circle diameter de, is not appropriate.

Therefore, the present inventor further made investigations and confirmed the following. In the case where de/(S/Swa) is used as a parameter, it is difficult for the value of de/(S/Swa), at which the supercharging air density is maximized, to be affected by the wall thickness of the inner fin. Accordingly, it has become possible to find the most appropriate specification of the core of the intercooler by using de/(S/Swa) as a parameter.

In the case of the intercooler of the present invention, in which the inner fins are composed of straight fins and the supercharging air pressure is not less than 200 kPa, it is possible to provide an intercooler of high performance, the supercharging air density of which is not less than 90% of the maximum value when de/(S/Swa) is set at 0.2 to 7.5.

In the case of the intercooler of the present invention in which the inner fins are composed of straight fins and the supercharging air pressure is not less than 200 kPa, it is possible to provide an intercooler of higher performance, the supercharging air density of which is not less than 95% of the maximum value when de/(S/Swa) is set at 0.3 to 4.5.

In the case of the intercooler of the present invention in which the inner fins are composed of straight fins and the supercharging air pressure is not less than 200 kPa, it is possible to provide an intercooler of much higher performance, the supercharging air density of which is not less than 97% of the maximum value when de/(S/Swa) is set at 0.5 to 3.5.

The present invention provides an intercooler, which is arranged on the downstream side of a supercharger for pressurizing suction air of an internal combustion engine, for cooling the suction air by exchanging heat between the suction air and a cooling fluid, comprising: tubes (10) composing passages in which the suction air flows; and inner fins (11), which are arranged in the tubes (10) so that the passages in the tubes (10) can be divided into a plurality of minute passages (100), for facilitating the heat exchange conducted between the suction air and the cooling fluid, wherein the inner fins (11) are straight fins, the wall faces (110) to divide the minute passages (100) of which are linearly extended in the flowing direction of the suction air, and the tubes (10) and the inner fins (11) are made of copper or copper alloy. The intercooler characterized in that: when a cross sectional area in one tube (10) is S, a total passage area of the minute passages (100) in one tube (10) is Swa and an equivalent circle diameter of one minute passage (100) is de (unit: mm), de/(S/Swa) is 0.2 to 7.5.

Due to the foregoing, in the case of the intercooler in which the inner fins are composed of straight fins and the tubes and inner fins are made of copper or a copper alloy, when de/(S/Swa) is set at 0.2 to 7.5, it is possible to provide an intercooler of high performance in which the supercharging air density is not less than 90% of the maximum value.

In the case of the intercooler of the present invention in which the inner fins are composed of straight fins and the tubes and inner fins are made of copper or a copper alloy, when de/(S/Swa) is set at 0.3 to 4.5, it is possible to provide an intercooler of higher performance in which the supercharging air density is not less than 95% of the maximum value.

Further, in the case of the intercooler of the present invention in which the inner fins are composed of straight fins and the tubes and inner fins are made of copper or copper alloy, when de/(S/Swa) is set at 0.5 to 3.5, it is possible to provide an intercooler, with a much higher performance, in which the supercharging air density is not less than 97% of the maximum value.

The present invention provides an intercooler, which is arranged on the downstream side of a supercharger for pressurizing suction air of an internal combustion engine, for cooling the suction air by exchanging heat between the suction air and a cooling fluid, comprising: tubes (10) composing passages in which the suction air flows; and inner fins (11), which are arranged in the tubes (10) so that the passages in the tubes (10) can be divided into a plurality of minute passages (100), for facilitating the heat exchange conducted between the suction air and the cooling fluid, wherein the inner fins (11) are offset fins, the wall faces (110) to divide the minute passages (100) of which are arranged zigzag in the flowing direction of the suction air, and the supercharging pressure is not less than 200 kPa. The intercooler characterized in that: when a cross sectional area in one tube (10) is S, a total passage area of the minute passages (100) in one tube (10) is Swa and an equivalent circle diameter of one minute passage (100) is de (unit: mm), de/(S/Swa) is 0.4 to 9.5.

Due to the foregoing, in the case of an intercooler in which the inner fins are composed of offset fins and the supercharging air pressure is not less than 200 kPa, when de/(S/Swa) is set at 0.4 to 9.5, it is possible to provide an intercooler, with a high performance, in which the supercharging air density is not less than 90% of the maximum value.

In the case of an intercooler of the present invention in which the inner fins are composed of offset fins and the supercharging air pressure is not less than 200 kPa, when de/(S/Swa) is set at 0.6 to 7.2, it is possible to provide an intercooler, with a higher performance, in which the supercharging air density is not less than 95% of the maximum value.

In the case of an intercooler of the present invention in which the inner fins are composed of offset fins and the supercharging air pressure is not less than 200 kPa, when de/(S/Swa) is set at 0.8 to 6.2, it is possible to provide an intercooler, with a higher performance, in which the supercharging air density is not less than 97% of the maximum value.

The present invention provides an intercooler, which is arranged on the downstream side of a supercharger for pressurizing suction air of an internal combustion engine, for cooling the suction air by exchanging heat between the suction air and a cooling fluid, comprising: tubes (10) composing passages in which the suction air flows; and inner fins (11), which are arranged in the tubes (10) so that the passages in the tubes (10) can be divided into a plurality of minute passages (100), for facilitating the heat exchange conducted between the suction air and the cooling fluid, wherein the inner fins (11) are offset fins, the wall faces (110) to divide the minute passages (100) of which are arranged zigzag in the flowing direction of the suction air, and the tubes (10) and the inner fins (11) are made of copper or copper alloy. The intercooler is characterized in that: when a cross sectional area in one tube (10) is S, a total passage area of the minute passages (100) in one tube (10) is Swa and an equivalent circle diameter of one minute passage (100) is de (unit: mm), de/(S/Swa) is 0.4 to 9.5.

Due to the foregoing, in the case of an intercooler in which the inner fins are composed of offset fins and the tubes and inner fins are made of copper or a copper alloy, when de/(S/Swa) is set at 0.4 to 9.5, it is possible to provide an intercooler, with a high performance, in which the supercharging air density is not less than 90% of the maximum value.

In the case of an intercooler of the present invention in which the inner fins are composed of offset fins and the tubes and inner fins are made of copper or a copper alloy, when de/(S/Swa) is set at 0.6 to 7.2, it is possible to provide an intercooler, with a higher performance, in which the supercharging air density is not less than 95% of the maximum value.

In the case of an intercooler of the present invention in which the inner fins are composed of offset fins and the tubes and inner fins are made of copper or a copper alloy, when de/(S/Swa) is set at 0.8 to 6.2, it is possible to provide an intercooler, with a higher performance, in which the supercharging air density is not less than 97% of the maximum value.

When the wall thickness of the inner fin (11) is smaller than 0.15 mm as described in the present invention, it is possible to use an intercooler in the high-performance range while the necessary mechanical strength of the intercooler is being ensured.

In this connection, reference numerals in the parentheses in each means described above denote a corresponding relation with the specific means described in an embodiment which will be explained later.

As explained below, by referring to the accompanying drawings, the present invention will be fully understood from the explanations of the preferred embodiments of the invention.

### BRIEF DESCRIPTION OF THE DRAWINGS

FIG. 1 is a front view showing an intercooler of the first embodiment.

FIG. 2 is an enlarged view showing a portion A in FIG. 1.

FIG. 3 is a sectional view taken on line B - B in FIG. 2.

FIG. 4 is a diagram showing a result of the calculation of the performance of the core 1 in the case where the straight fins are used in the first embodiment.

FIG. 5 is a diagram showing a result of the calculation of the performance of the core 1 in the case where the offset fins are used in the first embodiment.

FIG. 6 is a diagram showing a relation between the stress (S) and the number of cycles (N) of the repetition of the stress which the material endured in the second embodiment.

FIG. 7 is a characteristic diagram showing a relation between the wall thickness ti of the inner fin 11 and the stress given to the joint portion of the inner fin 11 in the second embodiment.

FIG. 8 is a diagram showing a result of the calculation of the performance of the intercooler in the case where the wall thickness ti of the inner fin 11 is changed in the second embodiment.

### DESCRIPTION OF THE PREFERRED EMBODIMENTS

### First Embodiment

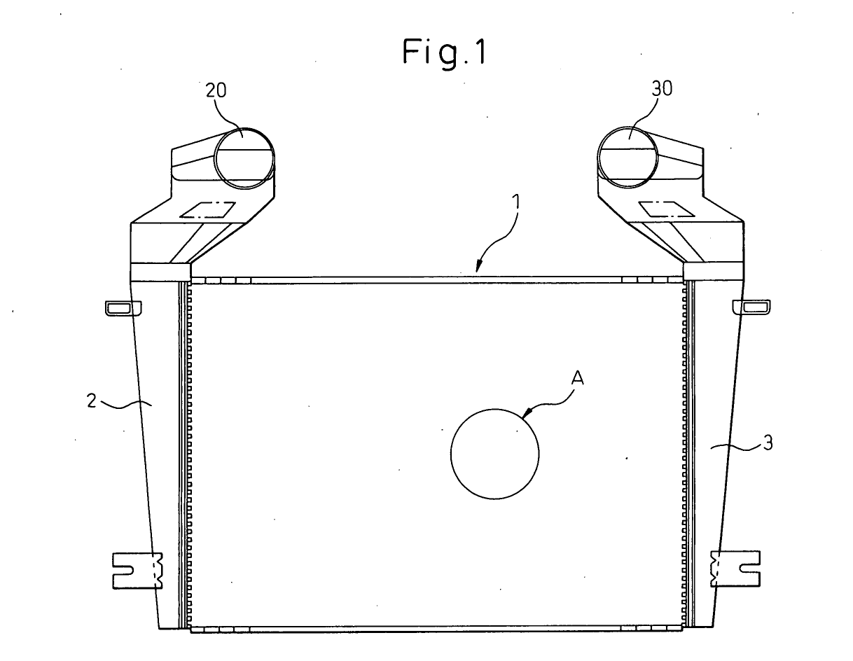

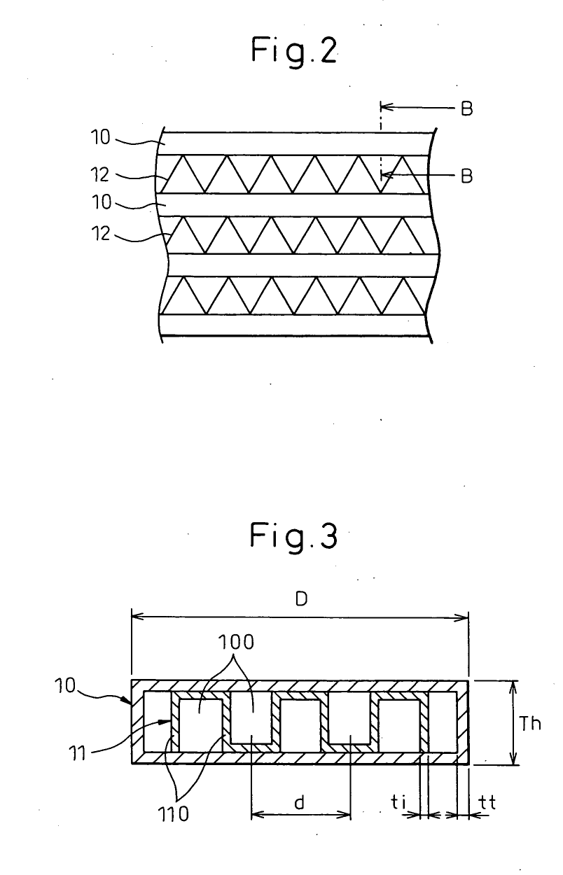

The first embodiment of the present invention will be explained below. FIG. 1 is a front view showing an intercooler of the first embodiment, FIG. 2 is an enlarged view showing a portion A in FIG. 1, and FIG. 3 is a sectional view taken on line B-B in FIG. 2.

The intercooler of this embodiment is arranged on the downstream side, in the suction air flow, of a supercharger (not shown) for pressurizing suction air to be sucked into an internal combustion engine (not shown). In this intercooler, heat is exchanged between the suction air and a cooling air flow, so that the suction air can be cooled. In this connection, the cooling air flow corresponds to a cooling fluid of the present invention.

As shown in FIG. 1 to 3, the core 1 of the intercooler includes: a large number of laminated flat tubes 10 in which passages for the suction air are formed; inner fins 11 arranged in the tubes 10; and outer fins 12 arranged between the laminated tubes 10.

Parts composing the core 1, that is, all of the tubes 10, the inner fins 11 and the outer fins 12 are made of copper or a copper alloy. More particularly, it is desirable that the parts composing the core 1 are made of material, the mechanical strength of which is high at a high temperature. For example, it is desirable that the parts composing the core 1 are made of a copper alloy to which chromium is added.

The outer fins 12 are formed into wave-shapes and joined to the tubes 10, so that heat exchange conducted between the cooling air flow, which flows between the tubes 10, and the suction air, which flows in the tubes 10, can be facilitated. In this connection, in order to prevent the growth of a boundary layer by disturbing the air flow, some portions of the outer fins 12 are cut and raised and formed into a louver (not shown).

The inner fins 11 are formed into wave-shapes and joined to the tubes 10, so that the heat exchange conducted between the cooling air flow and the suction air can be facilitated. The inner fins 11 have a large number of wall faces 110 for connecting the opposing faces of the tubes 10. The passages in the tubes 10 are divided into a plurality of minute passages 100. In this connection, no louvers are provided in the inner fins 11.

On both end sides of the tubes 10 in the longitudinal direction, the header tanks 2, 3 are provided which extend in the laminating direction of the tubes 10 and communicate with the tubes 10. The inlet portion 20 of one header tank 2 is connected to the supercharger, so that the suction air sent from the supercharger under pressure can be distributed and supplied to the tubes 10. The outlet portion 30 of the other header tank 3 is connected to the suction port of an internal combustion engine, so that the suction air flowing out from the tubes 10 can be collected and recovered and sent to the suction port of the internal combustion engine. Both the header tanks 2, 3 are made of copper or copper alloy.

When copper or a copper alloy is used for the material of the intercooler as described in this embodiment, it is possible to enhance the mechanical strength at high temperatures. Further, as the mechanical strength of copper is twice as high as that of aluminum, the wall thickness can be reduced.

Concerning the intercooler of this embodiment composed as described above, the most appropriate specification of the core 1 was investigated by finding the performance of the core 1 by the method of calculation in the case where the wall thickness ti (shown in FIG. 3, unit: mm) of the inner fin 11 was changed.

This investigation was made under the following conditions. First of all, the specification of the intercooler is described as follows. The inner fin 11 is a straight fin, the wall face 110 of which linearly extends in the flowing direction of the suction air in the tube 10.

Concerning the core 1, the width is 596.9 mm, the height is 886 mm and the thickness is 56 mm. In this connection, the width of the core 1 is a size of the core 1 in the lateral direction on the surface of FIG. 1, the height of the core 1 is a size of the core 1 in the upward and downward direction on the surface of FIG. 1, and the thickness of the core 1 is a size of the core 1 in the direction perpendicular to the surface of FIG. 1.

Concerning the tube 10, the height Th (shown in FIG. 3) is 5.9 mm, the thickness is 56 mm, and the wall thickness tt (shown in FIG. 3) is 0.3 mm. In this connection, the tube height Th is a size in the upward and downward direction on the surface of FIG. 1, and the tube thickness 10 is a size in the direction perpendicular to the surface of FIG. 1. Concerning the outer fin 12, the fin pitch is 4.0 mm and the wall thickness is 0.05 mm.

Conditions used in the calculation to calculate the performance of the core 1 are described as follows. The temperature of cooling air flow is 30° C. at the time when the cooling air flow flow into the intercooler, the velocity of the cooling air flow is 8 m/s, the temperature of the supercharging air (suction air) is 180° C. at the inlet portion 20 of the header tank 2, the pressure of the supercharging air is 200 kPa at the inlet portion 20 of the header tank 2, and the mass flow rate of the supercharging air is 2000 kg/hr.

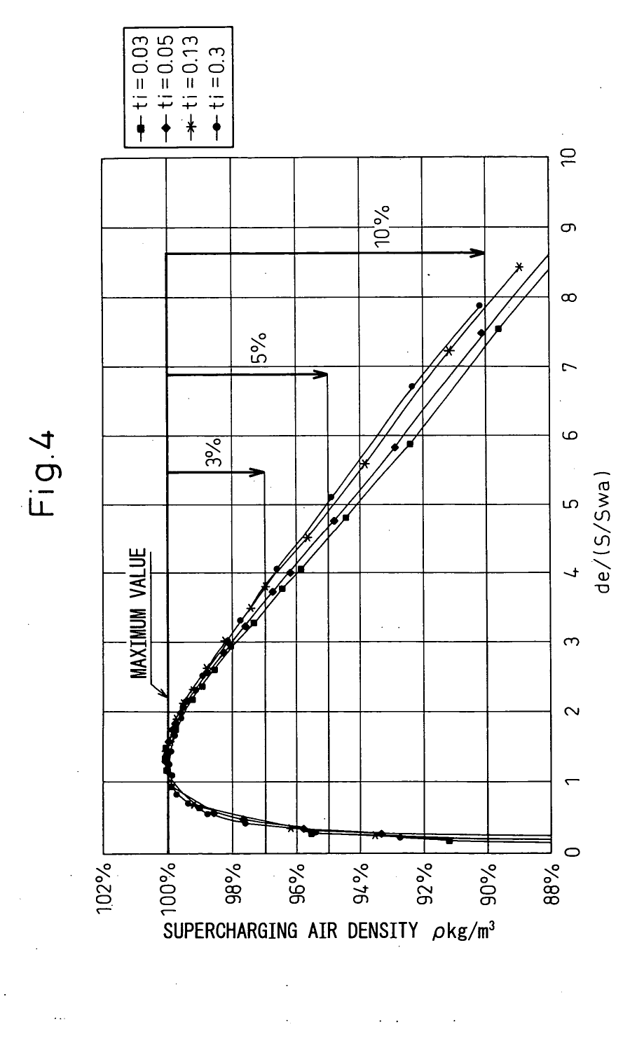

FIG. 4 is a diagram showing a result of the calculation of the performance of the core 1. The ordinate represents the density p of the supercharging air which has passed through the intercooler, and the abscissa represents the corrected equivalent circle diameter which was devised and employed by the present inventors. In this connection, when S is a cross sectional area of the surface perpendicular to the direction of the suction air flow in the tube 10, Swa is a total passage area of the minute passages 100 in one tube 10 and de (unit: mm) is an equivalent circle diameter of one minute passage 100, the corrected equivalent circle diameter is de/(S/Swa).

As can be seen in FIG. 4, in the case where the corrected equivalent circle diameter is used as a parameter, it is difficult for the value of the corrected equivalent circle diameter, at which the supercharging air density p is maximized, to be affected by the wall thickness ti of the inner fin 11. Accordingly, it becomes possible for the most appropriate specification of the core 1 to be found when the corrected equivalent circle diameter is used as a parameter.

To be specific, in the case of an intercooler in which the inner fin 11 is a straight fin and the supercharging pressure is not less than 200 kPa, or in the case of an intercooler in which the inner fin 11 is a straight fin and the tube and the inner fin 11 are made of copper or copper alloy, when the corrected equivalent circle diameter is made to be 0.2 to 7.5, the supercharging air density p becomes a value not less than 90% of the maximum value, and when the corrected equivalent circle diameter is made to be 0.3 to 4.5, the supercharging air density p becomes a value not less than 95% of the maximum value, and when the corrected equivalent circle diameter is made to be 0.5 to 3.5, the supercharging air density p becomes a value not less than 97% of the maximum value.

Next, the most appropriate specification was investigated in the case where the inner fin 11 was an offset fin. As is well known, the offset fin is defined as a fin which is arranged zigzag in the flowing direction of the suction air in the tube 10. In this connection, the other conditions are the same as those of the exemplary investigation described before.

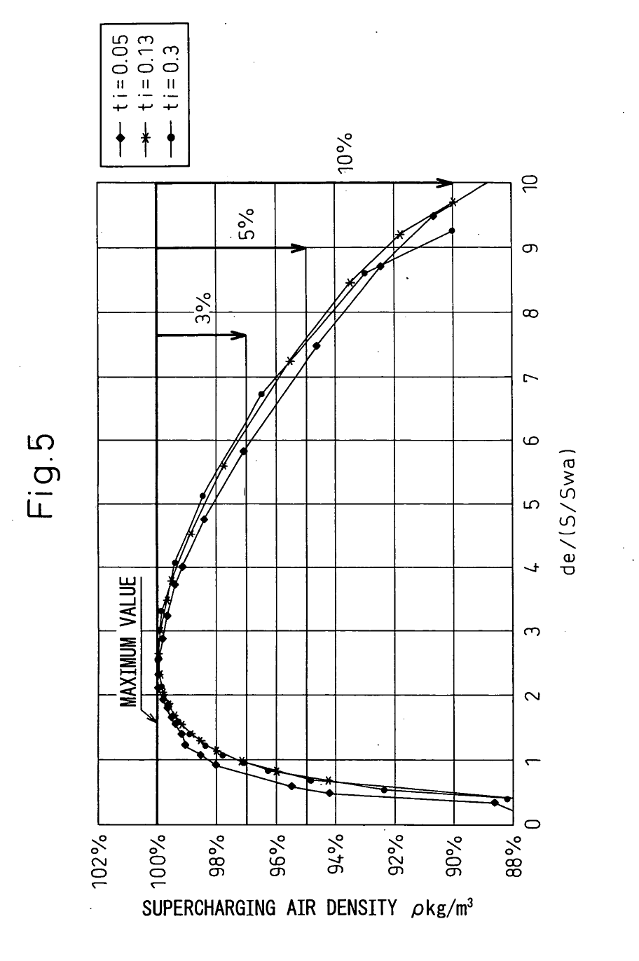

FIG. 5 is a diagram showing the result of the calculation. In the case of an intercooler in which the inner fin 11 is an offset fin and the supercharging pressure is not less than 200 kPa, or in the case of an intercooler in which the inner fin 11 is an offset fin and the tube 10 and the inner fin 11 are made of copper or a copper alloy, when the corrected equivalent circle diameter is made to be 0.4 to 9.5, the supercharging air density p becomes a value not less than 90% of the maximum value, and when the corrected equivalent circle diameter is made to be 0.6 to 7.2, the supercharging air density p becomes a value not less than 95% of the maximum value, and when the corrected equivalent circle diameter is made to be 0.8 to 6.2, the supercharging air density p becomes a value not less than 97% of the maximum value.

### Second Embodiment

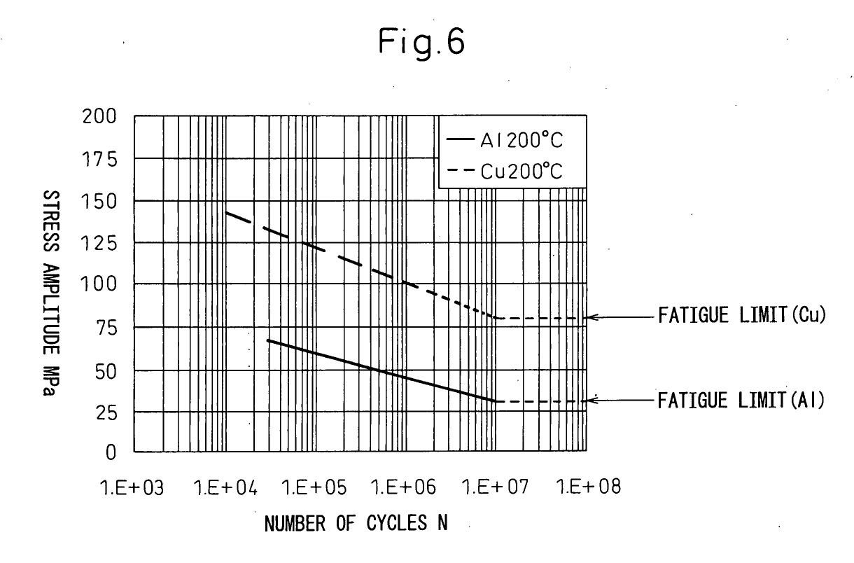

Next, referring to FIGS. 6 to 8, the second embodiment of the present invention will be explained below. Like reference characters are used to indicate like parts in the first and the second embodiment, and the explanations are omitted here.

In this embodiment, in the case of an intercooler in which offset fins were used for the inner fins 11 and the tubes 10 and the inner fins 11 were made of copper or copper alloy, the wall thickness ti of the inner fin 11 was investigated. As a result of the investigation, the present inventors found a range of appropriate wall thicknesses ti.

FIG. 6 is a diagram showing a relation between the stress (S) and the number of cycles (N) which endured the repetition of the stress (S). The axis of ordinate represents the stress amplitude σ and the axis of abscissa represents the number N of cycles.

First of all, the fatigue limits of copper and aluminum are found from FIG. 6. The fatigue limit is the maximum value of stress which can be repeatedly and infinitely given to material without causing fracture of the material. In this connection, no fatigue limit exists in aluminum. Therefore, in this embodiment, the maximum stress, by which the material is not damaged even when the stress is repeatedly given 10⁷ times, is defined as the fatigue limit for both copper and aluminum.

When the design stress of copper and that of aluminum were respectively calculated by the fatigue limit found before and according to the diagram shown in FIG. 6, the design stress of copper was 80 MPa, and the design stress of aluminum was 30 MPa.

Concerning the inner fin 11, the maximum stress is generated in the joint portion where the inner fin 11 and the inner wall of the tube 10 are joined to each other. Therefore, in the case of copper, the limit of wall thickness of the inner fin is found by the stress, which is given to this joint portion, and by the design stress which has been found before. In the case of aluminum, the limit of wall thickness of the inner fin is also found by the stress, which is given to this joint portion, and by the design stress which has been found before.

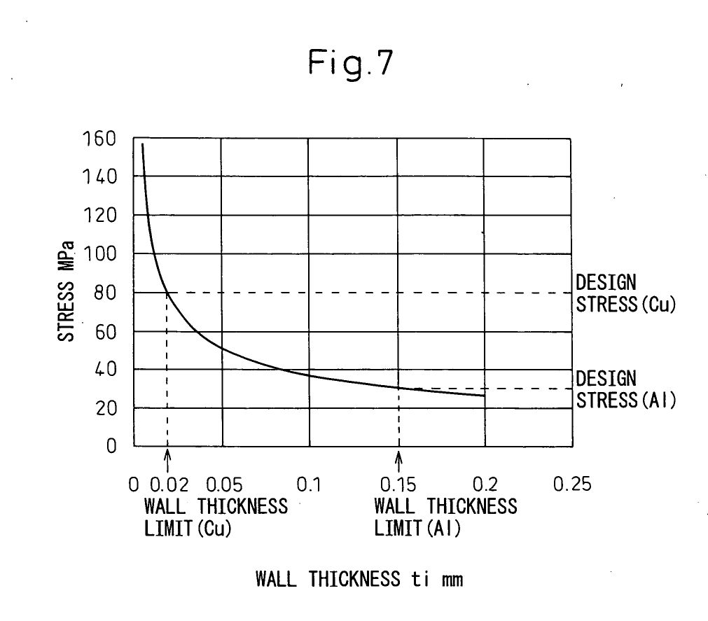

FIG. 7 is a characteristic diagram showing a relation between the wall thickness ti of the inner fin 11 at the time when the inner pressure kPa is given and the stress given to the joint portion of the inner fin 11. The axis of ordinate represents the stress given to the joint portion of the inner fin 11 and the inner wall of the tube 10, and the axis of abscissa represents the wall thickness ti of the inner fin 11.

As shown in FIG. 7, as the design stress was 80 MPa in the case of copper, the limit wall thickness of the inner fin 11 was 0.02 mm. On the other hand, as the design stress was 30 MPa in the case of aluminum, the limit wall thickness of the inner fin 11 was 0.15 mm.

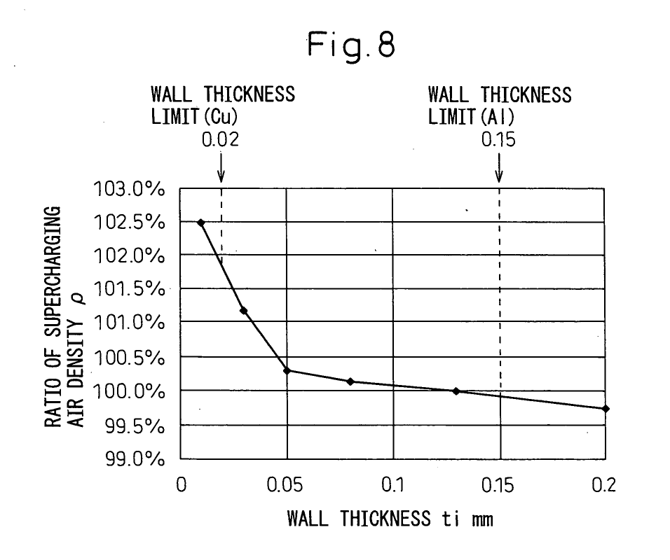

In this connection, in the case where the wall thickness ti of the inner fin 11 was changed, the performance of the intercooler was found by calculation. FIG. 8 is a diagram showing a result of the calculation of the performance of the intercooler of the second embodiment of the present invention. The ordinate represents the density p of the supercharging air which has passed through the intercooler, and the abscissa represents the wall thickness ti of the inner fin 11.

As can be seen in FIG. 8, when the wall thickness ti of the inner fin 11 is smaller than 0.15 mm, a range exists in which the performance of the intercooler is highly enhanced. Concerning the performance of the intercooler, when the wall thickness ti of the inner fin 11 is reduced, it is possible to provide an intercooler with a high performance.

However, in the case where the inner fin 11 is made of aluminum, the limit of wall thickness is 0.15 mm, which can not be put into practical use. Accordingly, when the inner fin 11 is made of copper including copper alloy and the wall thickness ti of the inner fin 11 smaller than 0.15 mm, the intercooler can be used in the high performance range while the necessary mechanical strength of the intercooler is ensured.

### Another Embodiment

In the first embodiment described above, the parts composing the core 1 are made of copper or a copper alloy. However, the present invention can be applied to an intercooler in which the parts composing the core 1 are made of material other than copper or copper alloy. For example, the present invention can be applied to an intercooler made of, for example, aluminum.

The present invention is explained above referring to the specific embodiments which have been selected for explaining the present invention. It is clear that variations may be made, by those skilled in the art, without departing from the scope and the fundamental concept of the present invention.

1. An intercooler, which is arranged on the downstream side of a supercharger for pressurizing suction air of an internal combustion engine, for cooling the suction air by exchanging heat between the suction air and a cooling fluid, comprising:
tubes composing passages in which the suction air flows; and
inner fins, which are arranged in the tubes so that the passages in the tubes can be divided into a plurality of minute passages, for facilitating the heat exchange conducted between the suction air and the cooling fluid, wherein
the inner fins are straight fins, the wall faces to divide the minute passages of which are linearly extended in the flowing direction of the suction air, and the supercharging pressure is not less than 200 kPa, the intercooler characterized in that:
when a cross sectional area in one tube is S, a total passage area of the minute passages in one tube is Swa and an equivalent circle diameter of one minute passage is de (unit: mm), de/(S/Swa) is 0.2 to 7.5.

2. An intercooler according to claim 1, wherein de/(S/Swa) is 0.3 to 4.5.

3. An intercooler according to claim 1, wherein de/(S/Swa) is 0.5 to 3.5.

4. An intercooler, which is arranged on the downstream side of a supercharger for pressurizing suction air of an internal combustion engine, for cooling the suction air by exchanging heat between the suction air and a cooling fluid, comprising:
tubes composing passages in which the suction air flows; and
inner fins, which are arranged in the tubes so that the passages in the tubes can be divided into a plurality of minute passages, for facilitating the heat exchange conducted between the suction air and the cooling fluid, wherein
the inner fins are straight fins, the wall faces to divide the minute passages of which are linearly extended in the flowing direction of the suction air, and the tubes and the inner fins are made of copper or a copper alloy,
the intercooler characterized in that: when a cross sectional area in one tube is S, a total passage area of the minute passages in one tube is Swa and an equivalent circle diameter of one minute passage is de (unit: mm),
de/(S/Swa) is 0.2 to 7.5.

5. An intercooler according to claim 4, wherein de/(S/Swa) is 0.3 to 4.5.

6. An intercooler according to claim 4, wherein de/(S/Swa) is 0.5 to 3.5.

7. An intercooler, which is arranged on the downstream side of a supercharger for pressurizing suction air of an internal combustion engine, for cooling the suction air by exchanging heat between the suction air and a cooling fluid, comprising:
tubes composing passages in which the suction air flows; and
inner fins, which are arranged in the tubes so that the passages in the tubes can be divided into a plurality of minute passages, for facilitating the heat exchange conducted between the suction air and the cooling fluid, wherein
the inner fins are offset fins, the wall faces to divide the minute passages of which are arranged zigzag in the flowing direction of the suction air, and the supercharging pressure is not less than 200 kPa, the intercooler characterized in that:
when a cross sectional area in one tube is S, a total passage area of the minute passages in one tube is Swa and an equivalent circle diameter of one minute passage is de (unit: mm), de/(S/Swa) is 0.4 to 9.5.

8. An intercooler according to claim 7, wherein de/(S/Swa) is 0.6 to 7.2.

9. An intercooler according to claim 7, wherein de/(S/Swa) is 0.8 to 6.2.

10. An intercooler, which is arranged on the downstream side of a supercharger for pressurizing suction air of an internal combustion engine, for cooling the suction air by exchanging heat between the suction air and a cooling fluid, comprising:
tubes composing passages in which the suction air flows; and
inner fins, which are arranged in the tubes so that the passages in the tubes can be divided into a plurality of minute passages, for facilitating the heat exchange conducted between the suction air and the cooling fluid, wherein
the inner fins are offset fins, the wall faces to divide the minute passages of which are arranged zigzag in the flowing direction of the suction air, and the tubes and the inner fins are made of copper or a copper alloy,
the intercooler characterized in that:
when a cross sectional area in one tube is S, a total passage area of the minute passages in one tube is Swa and an equivalent circle diameter of one minute passage is de (unit: mm), de/(S/Swa) is 0.4 to 9.5.

11. An intercooler according to claim 10, wherein de/(S/Swa) is 0.6 to 7.2.

12. An intercooler according to claim 10, wherein de/(S/Swa) is 0.8 to 6.2.

13. An intercooler according to claim 10, wherein the wall thickness of the inner fins is smaller than 0.15 mm.
